(19) United States
(12) Patent Application Publication
(10) Pub. No.: US 2023/0306081 A1
(43) Pub. Date: Sep. 28, 2023

(54) METHOD FOR TRAINING A POINT CLOUD PROCESSING MODEL, METHOD FOR PERFORMING INSTANCE SEGMENTATION ON POINT CLOUD, AND ELECTRONIC DEVICE

(71) Applicant: BEIJING BAIDU NETCOM SCIENCE TECHNOLOGY CO., LTD., Beijing (CN)

(72) Inventors: Xiaoqing YE, Beijing (CN); Ruihang CHU, Beijing (CN); Hao SUN, Beijing (CN)

(73) Assignee: BEIJING BAIDU NETCOM SCIENCE TECHNOLOGY CO., LTD., Beijing (CN)

(21) Appl. No.: 18/054,233

(22) Filed: Nov. 10, 2022

(30) Foreign Application Priority Data
Mar. 25, 2022 (CN) 202210306654.1

(51) Int. Cl. G06K 9/62; G06T 7/11

(52) U.S. Cl. CPC G06K 9/6259; G06K 9/6262; G06K 9/6218; G06K 9/6261; G06T 7/11; G06T 2207/10028; G06T 2207/20081

(57) ABSTRACT

A method for training a point cloud processing model and a method for performing instance segmentation on a point cloud are provided. The method includes: labeling an unlabeled point cloud according to a labeled point cloud to obtain a sample point cloud; inputting the sample point cloud to a point cloud processing model to obtain first predicted semantic information of the sample point cloud and a first predicted offset of the sample point cloud; determining a training loss according to the first predicted semantic information, the first predicted offset, a sample label corresponding to the sample point cloud, and original coordinate information of the sample point cloud; and training the point cloud processing model with the training loss.

### CROSS-REFERENCE TO RELATED APPLICATION(S)

This application claims priority to Chinese Patent Application No. 202210306654.1 filed Mar. 25, 2022, the disclosure of which is incorporated herein by reference in its entirety.

### TECHNICAL FIELD

The present disclosure relates to the technical field of artificial intelligence and, in particular, to the technical field of deep learning and computer vision, which is applicable to scenarios such as three-dimensional (3D) vision, augmented reality, and virtual reality.

### BACKGROUND

In the field of computer vision, instance segmentation of 3D vision is of great importance in real life. For example, in autonomous driving, vehicles and pedestrians on a road can be detected through the instance segmentation of 3D vision. In the 3D vision, a point cloud is a common data form, and the instance segmentation on the point cloud is the basis of 3D perception. Then, under the condition of a small and limited volume of labeled training data, how to accurately implement the instance segmentation on the point cloud is very important.

### SUMMARY

The present disclosure provides a method for training a point cloud processing model and a method for performing instance segmentation on a point cloud.

According to an aspect of the present disclosure, a method for training a point cloud processing model is provided. The method includes the steps described below.

An unlabeled point cloud is labeled according to a labeled point cloud such that a sample point cloud is obtained.

The sample point cloud is input to a point cloud processing model such that first predicted semantic information of the sample point cloud and a first predicted offset of the sample point cloud are obtained.

A training loss is determined according to the first predicted semantic information, the first predicted offset, a sample label corresponding to the sample point cloud, and original coordinate information of the sample point cloud.

The point cloud processing model is trained with the training loss.

According to another aspect of the present disclosure, a method for performing instance segmentation on a point cloud is provided. The method includes the steps described below.

A point cloud to be segmented is acquired.

Instance segmentation is performed, based on a point cloud processing model, on the point cloud to be segmented; where the point cloud processing model is trained through the method for training a point cloud processing model provided by the present disclosure.

The instance segmentation is performed, according to third predicted semantic information and a third predicted offset, on the point cloud to be segmented.

According to another aspect of the present disclosure, an electronic device is provided.

The electronic device includes at least one processor and a memory.

The memory is communicatively connected to the at least one processor.

The memory stores instructions executable by the at least one processor, and the instructions are executed by the at least one processor to cause the at least one processor to perform a method for training a point cloud processing model or a method for performing instance segmentation on a point cloud according to any embodiment of the present disclosure.

According to another aspect of the present disclosure, a non-transitory computer-readable storage medium storing computer instructions is provided, where the computer instructions are used for causing a computer to perform a method for training a point cloud processing model or a method for performing instance segmentation on a point cloud according to any embodiment of the present disclosure.

According to the technology of the present disclosure, the precision of the point cloud processing model is improved so that the accuracy with which the instance segmentation is performed on the point cloud is improved.

It is to be understood that the content described in this part is neither intended to identify key or important features of the embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the solution and not to limit the present disclosure. In the drawings:

FIG. 1 is a flowchart of a method for training a point cloud processing model according to an embodiment of the present disclosure;

FIG. 2 is a flowchart of another method for training a point cloud processing model according to an embodiment of the present disclosure;

FIG. 3 is a flowchart of another method for training a point cloud processing model according to an embodiment of the present disclosure;

FIG. 4 is a flowchart of a method for performing instance segmentation on a point cloud according to an embodiment of the present disclosure;

FIG. 5 is a structural diagram of a model training apparatus according to an embodiment of the present disclosure;

FIG. 6 is a structural diagram of an apparatus for performing instance segmentation on a point cloud according to an embodiment of the present disclosure; and

FIG. 7 is a block diagram of an electronic device for implementing a method for training a point cloud processing model or a method for performing instance segmentation on a point cloud according to an embodiment of the present disclosure.

### DETAILED DESCRIPTION

Example embodiments of the present disclosure, including details of embodiments of the present disclosure, are described hereinafter in conjunction with drawings to facilitate understanding. The example embodiments are illustrative only. Therefore, it is to be appreciated by those of ordinary skill in the art that various changes and modifications may be made to the embodiments described herein without departing from the scope and spirit of the present disclosure. Similarly, description of well-known functions and constructions is omitted hereinafter for clarity and conciseness.

It is to be noted that the terms “first” and “second” involved in the embodiments of the present disclosure are only introduced for the convenience of differentiation. There is no clear difference in sequence and number between the two terms.

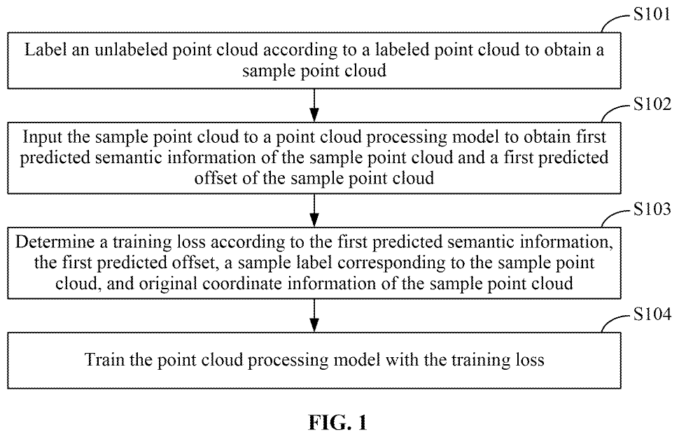

FIG. 1 is a flowchart of a method for training a point cloud processing model according to an embodiment of the present disclosure. The method is applicable to the case where instance segmentation is implemented on a point cloud accurately under the condition of a small and limited volume of labeled training data and, in particular, to the case where a model for performing instance segmentation on a point cloud is trained accurately under the condition of the small and limited volume of labeled training data to accurately implement the instance segmentation on the point cloud. The method may be performed by a model training apparatus. The apparatus may be implemented by software and/or hardware and may be integrated into an electronic device carrying a model training function. As shown in FIG. 1, the method for training a point cloud processing model in this embodiment may include the steps described below.

In S101, an unlabeled point cloud is labeled according to a labeled point cloud such that a sample point cloud is obtained.

In this embodiment, a point cloud is a set of all sampled points on an object surface. Optionally, the point cloud may be denoted by a set of a group of vectors in a three-dimensional coordinate system, which is used for representing the shape of the outer surface of an object in a scenario. Further, the point cloud may also include at least one type of color information such as an RGB value, a gray value, and depth information of each point. For example, the point cloud may be obtained based on a laser measurement principle or a principle of photogrammetry. Further, the point cloud may be collected with a laser radar, a stereo camera, or the like; or the point cloud may be acquired in another manner, which is not specifically limited in this embodiment.

The so-called labeled point cloud is point cloud data labeled with a true label. Correspondingly, the unlabeled point cloud is point cloud data that is not labeled with a label. Sample point clouds are point clouds required for training the model, which may include unlabeled point clouds labeled with pseudo-labels and labeled point clouds.

In an optional manner, points in the labeled point cloud and points in the unlabeled point cloud may be clustered such that at least one point set is obtained. Points in the at least one point set have the same label, that is to say, a label of each point in the point set is a label of the point set; and points in different point sets may have the same label or different labels. Then, for each point set among the at least one point set, if a point in the labeled point cloud exists in the point set, an unlabeled point in the point set is labeled with a labeled point in the point set, that is to say, a label of the labeled point in the point set is used as a pseudo-label of the unlabeled point in the point set. Further, all points in point sets including labeled points are used as the sample point cloud.

In S102, the sample point cloud is input to a point cloud processing model such that first predicted semantic information of the sample point cloud and a first predicted offset of the sample point cloud are obtained.

In this embodiment, predicted semantic information may also be referred to as predicted class information, that is, information about a prediction performed on the class of point cloud, which may include a class probability of the point cloud belonging to a certain class and a corresponding class name (or a corresponding class identifier). For example, there are four classes in a collection scenario of the point cloud, the four classes are a table, a chair, a person, and a vase, respectively, and predicted semantic information of a certain sample point cloud may be expressed as: [0.5 table, 0.2 chair, 0.2 person, 0.1 vase].

A predicted offset is an offset of the point cloud from the center of an instance that the point cloud belongs to, where the offset is obtained through a prediction. The so-called instance is used for embodying an abstract class concept with a specific object in the class, that is to say, the instance represents different individuals in the same class. For example, an instance in the table class represents specific individuals such as table 1 and table 2.

The so-called point cloud processing model may be a model constructed based on a neural network, for example, a pointwise prediction network, which is not specifically limited in this embodiment.

Specifically, each sample point cloud may be input to the point cloud processing model and processed by the model such that first predicted semantic information of each sample point cloud and a first predicted offset of each sample point cloud are obtained.

In S103, a training loss is determined according to the first predicted semantic information, the first predicted offset, a sample label corresponding to the sample point cloud, and original coordinate information of the sample point cloud.

In an optional manner, the training loss may be determined based on a preset loss function according to the first predicted semantic information of each sample point cloud, the first predicted offset of each sample point cloud, a sample label corresponding to each sample point cloud, and original coordinate information corresponding to each sample point cloud.

In S104, the point cloud processing model is trained with the training loss.

Specifically, the point cloud processing model is trained with the training loss, the training of the model is stopped until the training loss reaches a set range or the number of training iterations reaches a set number, and when the training is stopped, the point cloud processing model is used as a final point cloud processing model. The set range and the set number may be set by those skilled in the art according to actual situations.

According to the technical solution in the embodiment of the present disclosure, the unlabeled point cloud is labeled according to the labeled point cloud such that the sample point cloud is obtained, the sample point cloud is input to the point cloud processing model such that the first predicted semantic information of the sample point cloud and the first predicted offset of the sample point cloud are obtained, the training loss is determined according to the first predicted semantic information, the first predicted offset, the sample label corresponding to the sample point cloud, and the original coordinate information of the sample point cloud, and the point cloud processing model is trained with the training loss. According to the preceding technical solution, in a semi-supervised training scenario, the unlabeled point cloud is labeled so that the amount of point cloud data with the label is expanded, and the first predicted semantic information, the first predicted offset, the sample label, and the original coordinate information of the sample point cloud are introduced to determine a loss of the training model so that the accuracy of the determined training loss is ensured. Thus, the obtained point cloud processing model has relatively high precision so that the accuracy of a point cloud segmentation result is ensured.

Based on the preceding embodiment, as an optional embodiment of the present disclosure, that the unlabeled point cloud is labeled according to the labeled point cloud such that the sample point cloud is obtained may also be that supervoxel segmentation is performed on an original point cloud according to point cloud geometry information such that a first supervoxel is obtained; and an unlabeled point cloud in the first supervoxel is labeled according to a labeled point cloud in the first supervoxel such that the sample point cloud is obtained.

The point cloud geometry information may include structure information of the point cloud and/or color information of the point cloud. Original point clouds include the labeled point clouds and unlabeled point clouds. The so-called first supervoxels are point cloud regions having similar geometry information, and multiple first supervoxels exist. Further, the first supervoxels may be divided into two types, that is, first-type supervoxels and second-type supervoxels, where the first-type supervoxels are supervoxels containing labeled point clouds, and the second-type supervoxels are supervoxels including no labeled point cloud, that is, all the supervoxels constituted by unlabeled point clouds.

Specifically, the supervoxel segmentation may be performed, based on a supervoxel segmentation algorithm, on the original point cloud according to the point cloud geometry information such that the first supervoxel is obtained. The supervoxel segmentation algorithm may be a voxel cloud connectivity segmentation (VCCS) algorithm or the like, which is not specifically limited in this embodiment. Then, for each first supervoxel (that is, the first-type supervoxel) containing the labeled point clouds, unlabeled point clouds in the first-type supervoxel are labeled according to the labeled point clouds in the first-type supervoxel. That is to say, a label corresponding to the labeled point clouds in the first-type supervoxel is added to the unlabeled point clouds in the first-type supervoxel, and it may be also understood that all point clouds in the first-type supervoxel have the same label that is the label of the labeled point clouds in the first-type supervoxel. Further, all the point clouds in the first-type supervoxel are used as the sample point clouds.

It is to be understood that the supervoxel segmentation is performed on the original point cloud such that more labeled point clouds are obtained, thereby increasing the amount of sample point clouds.

As an optional manner of the present disclosure, that the training loss is determined according to the first predicted semantic information, the first predicted offset, the sample label corresponding to the sample point cloud, and the original coordinate information of the sample point cloud may also be that a first loss is determined according to the first predicted semantic information and a semantic label in the sample label corresponding to the sample point cloud, a second loss is determined according to the first predicted offset and the original coordinate information of the sample point cloud, and then the training loss is determined according to the first loss and the second loss, for example, the weighted sum of the first loss and the second loss may be used as the training loss.

Specifically, the first loss may be determined based on the preset loss function (for example, a cross-entropy loss function) according to the first predicted semantic information and the semantic label in the sample label corresponding to the sample point cloud. In addition, a consistency supervision may be introduced during the training, that is, results of first predicted offsets of point clouds belonging to the same supervoxel plus original coordinate information of the point clouds belonging to the same supervoxel are made to be as equal as possible. That is to say, all the point clouds belonging to the same supervoxel are made to point to the center of the same instance as much as possible. Specifically, for each point cloud in the same first-type supervoxel, a first predicted offset of the point cloud and original coordinate information of the point cloud are summed, and the standard deviation of all the summation operation results is calculated; and standard deviations corresponding to all the first-type supervoxels are averaged such that the second loss may be obtained. For example, the second loss may be calculated through the following formula:

$${L}_{consist} = \frac{1}{K} Std ( \vert {p}_{i}^{u} + {o}_{i}^{u} \vert , {p}_{i}^{u} ∈ {s}_{j}^{u} )$$

where sⱼ^{u} denotes a j-th first-type supervoxel, pᵢ^{u} denotes a first predicted offset of an i-th point cloud, oᵢ^{u} denotes original coordinate information of the i-th point cloud, k denotes the number of first-type supervoxels, and Std denotes a standard deviation for the subsequent set.

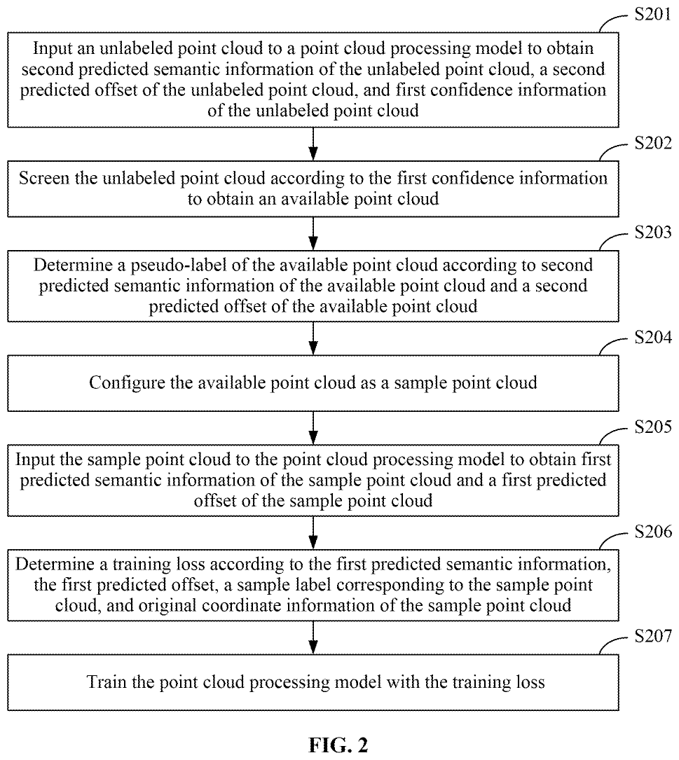

FIG. 2 is a flowchart of another method for training a point cloud processing model according to an embodiment of the present disclosure. Based on the preceding embodiment, that “the unlabeled point cloud is labeled according to the labeled point cloud such that the sample point cloud is obtained” is further optimized in this embodiment, and an optional implementation solution is provided. As shown in FIG. 2, the method for training a point cloud processing model in this embodiment may include the steps described below.

In S201, the unlabeled point cloud is input to the point cloud processing model such that second predicted semantic information of the unlabeled point cloud, a second predicted offset of the unlabeled point cloud, and first confidence information of the unlabeled point cloud are obtained.

In this embodiment, an initial model is trained with the labeled point cloud such that the point cloud processing model is obtained. The initial model may be a model constructed based on a neural network, for example, a pointwise prediction network, which is not specifically limited in this embodiment.

The unlabeled point clouds in this embodiment may be point clouds except the labeled point clouds in the original point clouds. Further, the unlabeled point clouds in the embodiment may also be all point clouds in a second-type supervoxel.

The so-called first confidence information is an index to measure the credibility of a predicted result of semantic information.

Specifically, the unlabeled point cloud is input to the point cloud processing model and processed by the model such that the second predicted semantic information of the unlabeled point cloud, the second predicted offset of the unlabeled point cloud, and the first confidence information of the unlabeled point cloud may be obtained.

In S202, the unlabeled point cloud is screened according to the first confidence information such that an available point cloud is obtained.

In this embodiment, the available point cloud may be used for subsequent model training.

Specifically, the unlabeled point cloud that has the first confidence information greater than a set value is used as the available point cloud. The set value may be set by those skilled in the art according to the actual situations, for example, the set value is 0.5.

In S203, a pseudo-label of the available point cloud is determined according to second predicted semantic information of the available point cloud and a second predicted offset of the available point cloud.

Optionally, the pseudo-label may include a semantic pseudo-label and an offset pseudo-label, where the semantic pseudo-label is a pseudo-label characterizing semantics of the point cloud, and the offset pseudo-label is a pseudo-label characterizing an offset of the point cloud from an instance center of the point cloud.

In an optional manner, the semantic pseudo-label of the available point cloud is determined according to the second predicted semantic information of the available point cloud; and the offset pseudo-label of the available point cloud is determined according to the second predicted offset of the available point cloud.

Specifically, for each available point cloud, a semantic pseudo-label of the available point cloud may be determined according to a class corresponding to a highest class probability in second predicted semantic information of the available point cloud. For example, there are four classes in a collection scenario of the point cloud, the four classes are a table, a chair, a person, and a vase, respectively, and second predicted semantic information of a certain available point cloud is: [0.5 table, 0.2 chair, 0.2 person, 0.1 vase]. Then, the table may be used as a semantic pseudo-label of the available point cloud, that is to say, the probability of the available point cloud being the table is 1, and the probability of the available point cloud being another class is 0, which may be expressed as [1, 0, 0, 0].

Then, an offset pseudo-label of each available point cloud is determined according to a second predicted offset of each available point cloud. For example, the available point cloud may be clustered based on the second predicted offset of each available point cloud such that a cluster center is obtained; and for each available point cloud, the difference between original coordinate information of the available point cloud and coordinates of the cluster center corresponding to the available point cloud may be used as the offset pseudo-label of the available point cloud.

In S204, the available point cloud is used as the sample point cloud.

In this embodiment, the available point cloud labeled with the pseudo-label may be used as the sample point cloud.

In S205, the sample point cloud is input to the point cloud processing model such that first predicted semantic information of the sample point cloud and a first predicted offset of the sample point cloud are obtained.

In S206, a training loss is determined according to the first predicted semantic information, the first predicted offset, a sample label corresponding to the sample point cloud, and original coordinate information of the sample point cloud.

In S207, the point cloud processing model is trained with the training loss.

According to the technical solution in the embodiment of the present disclosure, the unlabeled point cloud is input to the point cloud processing model such that the second predicted semantic information of the unlabeled point cloud, the second predicted offset of the unlabeled point cloud, and the first confidence information of the unlabeled point cloud are obtained. The unlabeled point cloud is screened according to the first confidence information such that the available point cloud is obtained, then the pseudo-label of the available point cloud is determined according to the second predicted semantic information of the available point cloud and the second predicted offset of the available point cloud. The available point cloud is configured as the sample point cloud, the sample point cloud is input to the point cloud processing model such that the first predicted semantic information of the sample point cloud and the first predicted offset of the sample point cloud are obtained, the training loss is determined according to the first predicted semantic information, the first predicted offset, the sample label corresponding to the sample point cloud, and the original coordinate information of the sample point cloud, and the point cloud processing model is trained with the training loss. According to the preceding technical solution, the first confidence information is introduced to screen the unlabeled point cloud so that the quality of the determined sample point cloud is ensured, and the second predicted semantic information and the second predicted offset are used for determining the pseudo-label of the available point cloud so that the pseudo-label of the obtained available point cloud is enriched, thereby ensuring the accuracy of the point cloud processing model.

Based on the preceding embodiment, as an optional manner of the present disclosure, that the offset pseudo-label of the available point cloud is determined according to the second predicted offset of the available point cloud may also be that associated point clouds of a second supervoxel are determined from available point clouds; an instance center corresponding to the second supervoxel is determined according to second predicted offsets of the associated point clouds and original coordinate information of the associated point clouds. An offset pseudo-label of an associated point cloud is determined according to the instance center corresponding to the second supervoxel and original coordinate information of the associated point cloud, and the offset pseudo-label of the associated point cloud is used as the offset pseudo-label of the available point cloud.

The second supervoxel may be a supervoxel constituted by point clouds except point clouds with low confidence in the second-type supervoxel. Further, second supervoxels may also be obtained through the supervoxel segmentation on the available point clouds, that is, each group of the available point clouds after the segmentation correspond to one second supervoxel. Accordingly, the associated point clouds of the second supervoxel are the available point clouds included by the second supervoxel.

For example, for each second supervoxel, the sum of original coordinate information and a second predicted offset of each associated point cloud in the second supervoxel is calculated, and the mean of all the summation operation results in the second supervoxel is calculated and used as the instance center corresponding to the second supervoxel. Alternatively, the median of all the summation operation results in the second supervoxel is calculated and used as the instance center corresponding to the second supervoxel. Alternatively, the mode of all the summation operation results in the second supervoxel is calculated and used as the instance center corresponding to the second supervoxel.

After the instance center corresponding to the second supervoxel is determined, that the offset pseudo-label of the associated point cloud is determined according to the instance center corresponding to the second supervoxel and the original coordinate information of the associated point cloud may include that the distance between instance centers corresponding to pairwise second supervoxels is calculated, and if the distance between instance centers corresponding to any two second supervoxels is less than a distance threshold and the two second supervoxels have the same semantic pseudo-label, the two second supervoxels are combined such that a third supervoxel is obtained.

For each third supervoxel, the mean of the sums of second predicted offsets and original coordinate information of associated point clouds in the third supervoxel is calculated; and then, for each associated point cloud in the third supervoxel, the difference between original coordinate information of the associated point cloud and the mean is used as the offset pseudo-label of the associated point cloud.

After the offset pseudo-label of the associated point cloud is determined, the offset pseudo-label of the associated point cloud is configured as the offset pseudo-label of the available point cloud.

It is to be understood that the second supervoxel is introduced to determine the offset pseudo-label of the available point cloud so that the efficiency with which the offset pseudo-label of the available point cloud is determined is improved on condition that the quality of the offset pseudo-label of the available point cloud is ensured.

Accordingly, based on the preceding embodiment, as an optional manner of the present disclosure, that the training loss is determined according to the first predicted semantic information, the first predicted offset, the sample label corresponding to the sample point cloud, and the original coordinate information of the sample point cloud may also be that a first loss is determined according to the first predicted semantic information and a semantic label in the sample label corresponding to the sample point cloud, a second loss is determined according to the first predicted offset and the original coordinate information of the sample point cloud, a third loss is determined according to the first predicted offset and an offset label in the sample label, and the training loss is determined according to the first loss, the second loss, and the third loss.

Specifically, the first loss may be determined based on a preset loss function (for example, a cross-entropy loss), the first predicted semantic information, and the semantic label in the sample label corresponding to the sample point cloud. In addition, the second loss is determined according to the first predicted offset and the original coordinate information of the sample point cloud. Specifically, for each point cloud in the same second supervoxel, a first predicted offset of the point cloud and original coordinate information of the point cloud may be summed, and the standard deviation of all the summation operation results is calculated; and standard deviations corresponding to all the second supervoxels that the labeled point clouds belong to are averaged such that the second loss may be obtained. The third loss may be determined based on the preset loss function, the first predicted offset, and the offset label in the sample label. Finally, a weighted summation is performed on the first loss, the second loss, and the third loss such that the training loss is obtained.

It is to be understood that the supervision of the predicted offset is introduced to determine the training loss so that the accuracy of a point cloud segmentation model is ensured.

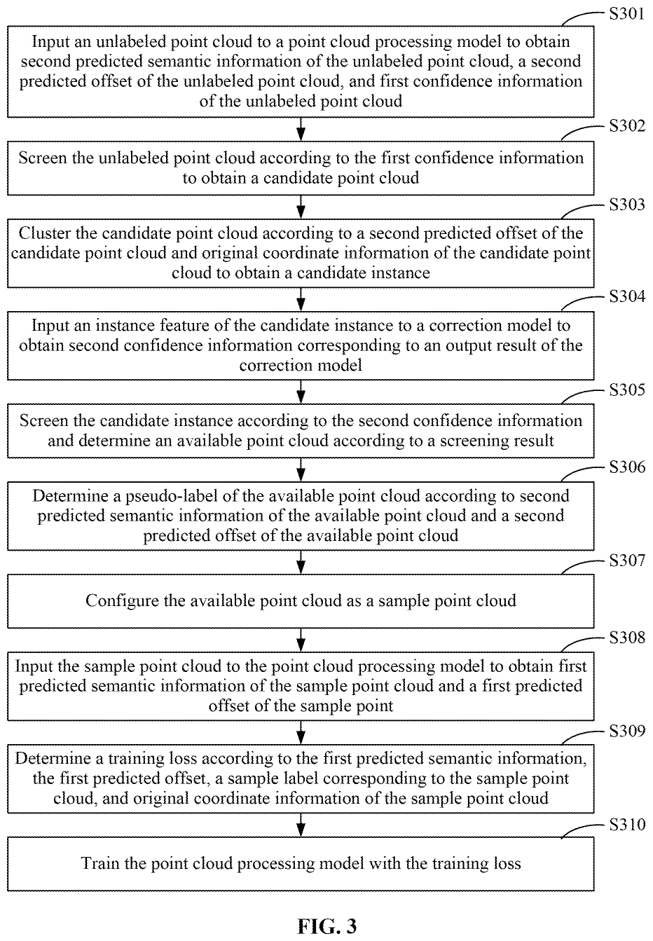

FIG. 3 is a flowchart of another method for training a point cloud processing model according to an embodiment of the present disclosure. Based on the preceding embodiment, that “the unlabeled point cloud is screened according to the first confidence information such that the available point cloud is obtained” is further optimized in this embodiment, and an optional implementation solution is provided. As shown in FIG. 3, the method for training a point cloud processing model in this embodiment may include the steps described below.

In S301, the unlabeled point cloud is input to the point cloud processing model such that second predicted semantic information of the unlabeled point cloud, a second predicted offset of the unlabeled point cloud, and first confidence information of the unlabeled point cloud are obtained.

An initial model is trained with the labeled point cloud such that the point cloud processing model is obtained.

In S302, the unlabeled point cloud is screened according to the first confidence information such that a candidate point cloud is obtained.

Specifically, the unlabeled point cloud that has the first confidence information exceeding a confidence threshold is used as the candidate point cloud. The confidence threshold may be set by those skilled in the art according to the actual situations.

In S303, the candidate point cloud is clustered according to a second predicted offset of the candidate point cloud and original coordinate information of the candidate point cloud such that a candidate instance is obtained.

Specifically, for each candidate point cloud, the sum of a second predicted offset of the candidate point cloud and original coordinate information of the candidate point cloud is calculated, and then each candidate point cloud is clustered according to the sum of the second predicted offset of each candidate point cloud and the original coordinate information of each candidate point cloud such that the candidate instance is obtained.

In S304, an instance feature of the candidate instance is input to a correction model such that second confidence information corresponding to an output result of the correction model is obtained.

In this embodiment, the instance feature is a result obtained by splicing pointwise high-level information of the point cloud and the original coordinate information of the point cloud. The so-called correction model may be a multilayer perceptron (MLP) built by several layers of lightweight sparse convolutions.

Specifically, for each candidate instance, the instance feature corresponding to the candidate instance is input to the correction model such that a semantic class of the candidate instance and the second confidence information corresponding to the semantic class are obtained.

In S305, the candidate instance is screened according to the second confidence information and the available point cloud is determined according to a screening result.

Specifically, for each candidate instance, if the second confidence information corresponding to the semantic class of the candidate instance is greater than a set threshold, point clouds contained in the candidate instance may be retained; and if the second confidence information corresponding to the semantic class of the candidate instance is less than the set threshold, the point clouds contained in the candidate instance are deleted. Then, all the retained point clouds contained in the candidate instance are used as available point clouds.

In S306, a pseudo-label of the available point cloud is determined according to second predicted semantic information of the available point cloud and a second predicted offset of the available point cloud.

In S307, the available point cloud is configured as the sample point cloud.

In S308, the sample point cloud is input to the point cloud processing model such that first predicted semantic information of the sample point cloud and a first predicted offset of the sample point cloud are obtained.

In S309, a training loss is determined according to the first predicted semantic information, the first predicted offset, a sample label corresponding to the sample point cloud, and original coordinate information of the sample point cloud.

In S310, the point cloud processing model is trained with the training loss.

According to the technical solution in the embodiment of the present disclosure, the unlabeled point cloud is screened according to the first confidence information such that the candidate point cloud is obtained, the candidate point cloud is clustered according to the second predicted offset of the candidate point cloud and the original coordinate information of the candidate point cloud such that the candidate instance is obtained. Then, the instance feature of the candidate instance is input to the correction model such that the second confidence information corresponding to the output result of the correction model is obtained, and the candidate instance is screened according to the second confidence information and the available point cloud is determined according to the screening result. According to the preceding technical solution, the candidate point cloud is determined with the first confidence information such that the candidate instance is obtained and the point cloud is screened from the candidate instance according to the second confidence information so that the available point cloud is determined more accurately, thereby ensuring the accuracy of the pseudo-label of the available point cloud.

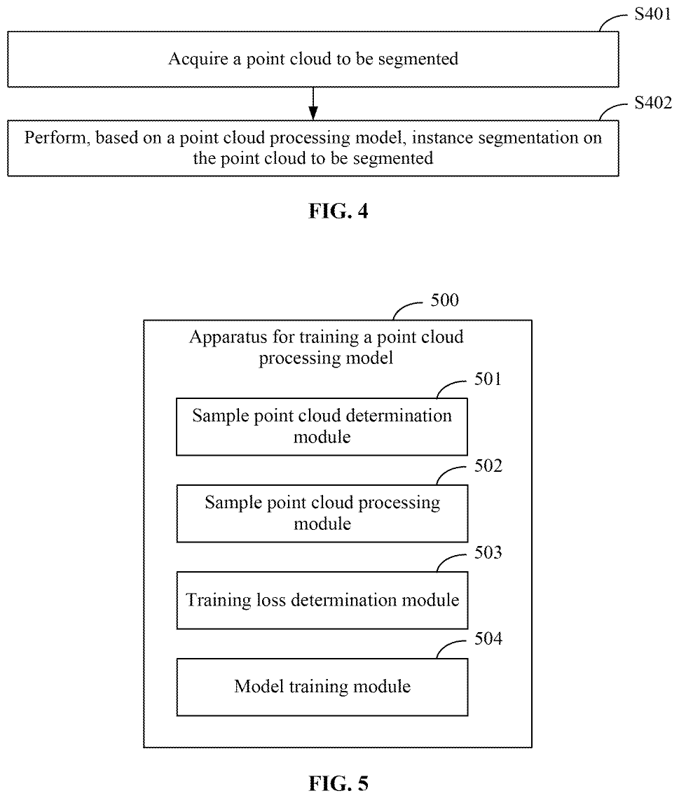

FIG. 4 is a flowchart of a method for performing instance segmentation on a point cloud according to an embodiment of the present disclosure. The method is applicable to the case where the instance segmentation is performed on the point cloud. The method may be performed by an apparatus for performing instance segmentation on a point cloud. The apparatus may be implemented by software and/or hardware and may be integrated into an electronic device carrying the function of performing the instance segmentation on the point cloud. As shown in FIG. 4, the method for performing instance segmentation on a point cloud in this embodiment may include the steps described below.

In S401, a point cloud to be segmented is acquired.

In this embodiment, the point cloud to be segmented is a point cloud that the instance segmentation needs to be performed on.

In S402, the instance segmentation is performed on the point cloud to be segmented based on a point cloud processing model.

Specifically, the point cloud to be segmented may be input to the point cloud processing model such that third predicted semantic information of the point cloud to be segmented and a third predicted offset of the point cloud to be segmented are obtained.

In this embodiment, the point cloud processing model is trained through the method for training a point cloud processing model according to any one of the preceding embodiments. The third predicted semantic information is predicted information of semantics of the point cloud to be segmented. The third predicted offset is a predicted value of an offset of the point cloud to be segmented.

Specifically, the point cloud to be segmented is input to the point cloud processing model and processed by the model such that the third predicted semantic information of the point cloud to be segmented and the third predicted offset of the point cloud to be segmented are obtained. The instance segmentation is performed on the point cloud to be segmented according to the third predicted semantic information and the third predicted offset.

Optionally, for each point cloud to be segmented, the sum of a third predicted offset of the point cloud to be segmented and original coordinate information of the point cloud to be segmented is calculated, and then each point cloud to be segmented is clustered according to the sum of the third predicted offset of each point cloud to be segmented and the original coordinate information of each point cloud to be segmented such that at least one cluster of point cloud sets is obtained. Then, the point clouds to be segmented that are in the at least one cluster of point cloud sets and have the same third predicted semantic information are divided into the same instance.

According to the technical solution in this embodiment, the point cloud to be segmented is acquired, and the instance segmentation is performed on the point cloud to be segmented based on the point cloud processing model. According to the preceding technical solution, the instance segmentation is performed, through the point cloud processing model, on the point cloud to be segmented so that the accuracy with which the instance segmentation is performed on the point cloud is improved.

FIG. 5 is a structural diagram of an apparatus for training a point cloud processing model according to an embodiment of the present disclosure. This embodiment is applicable to the case where instance segmentation is implemented on a point cloud accurately under the condition of a small and limited volume of labeled training data and, in particular, to the case where a model for performing instance segmentation on a point cloud is trained accurately under the condition of the small and limited volume of labeled training data to accurately implement the instance segmentation on the point cloud. The apparatus may be implemented by software and/or hardware and may be integrated into an electronic device carrying a model training function. As shown in FIG. 5, an apparatus 500 for training a point cloud processing model in this embodiment may include a sample point cloud determination module 501, a sample point cloud processing module 502, a training loss determination module 503, and a model training module 504.

The sample point cloud determination module 501 is configured to label an unlabeled point cloud according to a labeled point cloud to obtain a sample point cloud.

The sample point cloud processing module 502 is configured to input the sample point cloud to a point cloud processing model to obtain first predicted semantic information of the sample point cloud and a first predicted offset of the sample point cloud.

The training loss determination module 503 is configured to determine a training loss according to the first predicted semantic information, the first predicted offset, a sample label corresponding to the sample point cloud, and original coordinate information of the sample point cloud.

The model training module 504 is configured to train the point cloud processing model with the training loss.

According to the technical solution in the embodiment of the present disclosure, the unlabeled point cloud is labeled according to the labeled point cloud such that the sample point cloud is obtained, the sample point cloud is input to the point cloud processing model such that the first predicted semantic information of the sample point cloud and the first predicted offset of the sample point cloud are obtained, the training loss is determined according to the first predicted semantic information, the first predicted offset, the sample label corresponding to the sample point cloud, and the original coordinate information of the sample point cloud, and the point cloud processing model is trained with the training loss. According to the preceding technical solution, in a semi-supervised training scenario, the unlabeled point cloud is labeled so that the amount of point cloud data with a label is expanded, and the first predicted semantic information, the first predicted offset, the sample label, and the original coordinate information of the sample point cloud are introduced to determine a loss of the training model so that the accuracy of the determined training loss is ensured. Thus, the obtained point cloud processing model has relatively high precision so that the accuracy of a point cloud segmentation result is ensured.

Further, the sample point cloud determination module 501 includes a first supervoxel determination unit and a first sample point cloud determination unit.

The first supervoxel determination unit is configured to perform supervoxel segmentation on an original point cloud according to point cloud geometry information to obtain a first supervoxel.

The first sample point cloud determination unit is configured to label an unlabeled point cloud in the first supervoxel according to a labeled point cloud in the first supervoxel to obtain the sample point cloud.

Further, the sample point cloud determination module 501 also includes an unlabeled point cloud information determination unit, an available point cloud determination unit, a pseudo-label determination unit, and a second sample point cloud determination unit.

The unlabeled point cloud information determination unit is configured to input the unlabeled point cloud to the point cloud processing model to obtain second predicted semantic information of the unlabeled point cloud, a second predicted offset of the unlabeled point cloud, and first confidence information of the unlabeled point cloud; where an initial model is trained with the labeled point cloud such that the point cloud processing model is obtained.

The available point cloud determination unit is configured to screen the unlabeled point cloud according to the first confidence information to obtain an available point cloud.

The pseudo-label determination unit is configured to determine a pseudo-label of the available point cloud according to second predicted semantic information of the available point cloud and a second predicted offset of the available point cloud.

The second sample point cloud determination unit is configured to configure the available point cloud as the sample point cloud.

Further, the pseudo-label determination unit includes a semantic pseudo-label determination sub-unit and an offset pseudo-label determination sub-unit.

The semantic pseudo-label determination sub-unit is configured to determine a semantic pseudo-label of the available point cloud according to the second predicted semantic information of the available point cloud.

The offset pseudo-label determination sub-unit is configured to determine an offset pseudo-label of the available point cloud according to the second predicted offset of the available point cloud.

Further, the offset pseudo-label determination sub-unit is configured to perform the operations described below.

Associated point clouds of a second supervoxel are determined from available point clouds.

An instance center corresponding to the second supervoxel is determined according to second predicted offsets of the associated point clouds and original coordinate information of the associated point clouds.

An offset pseudo-label of an associated point cloud is determined according to the instance center corresponding to the second supervoxel and original coordinate information of the associated point cloud.

The offset pseudo-label of the associated point cloud is used as the offset pseudo-label of the available point cloud.

Further, the available point cloud determination unit is configured to perform the operations described below.

The unlabeled point cloud is screened according to the first confidence information to obtain a candidate point cloud.

The candidate point cloud is clustered according to a second predicted offset of the candidate point cloud and original coordinate information of the candidate point cloud to obtain a candidate instance.

An instance feature of the candidate instance is input to a correction model to obtain second confidence information corresponding to an output result of the correction model.

The candidate instance is screened according to the second confidence information and the available point cloud is determined according to a screening result.

Further, the training loss determination module 503 is configured to perform the operations described below.

A first loss is determined according to the first predicted semantic information and a semantic label in the sample label corresponding to the sample point cloud.

A second loss is determined according to the first predicted offset and the original coordinate information of the sample point cloud.

A third loss is determined according to the first predicted offset and an offset label in the sample label.

The training loss is determined according to the first loss, the second loss, and the third loss.

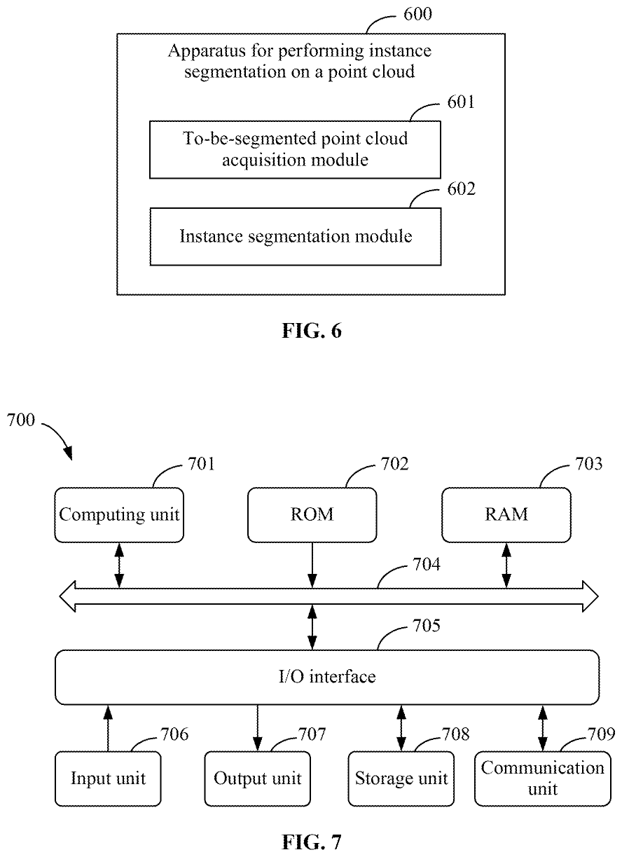

FIG. 6 is a structural diagram of an apparatus for performing instance segmentation on a point cloud according to an embodiment of the present disclosure. This embodiment is applicable to the case where the instance segmentation is performed on the point cloud. The apparatus may be implemented by software and/or hardware and may be integrated into an electronic device carrying the function of performing the instance segmentation on the point cloud. As shown in FIG. 6, an apparatus 600 for performing instance segmentation on a point cloud in this embodiment may include a to-be-segmented point cloud acquisition module 601 and an instance segmentation module 602.

The to-be-segmented point cloud acquisition module 601 is configured to acquire a point cloud to be segmented.

The instance segmentation module 602 is configured to perform, based on a point cloud processing model, the instance segmentation on the point cloud to be segmented; where the point cloud processing model is trained through the method for training a point cloud processing model according to any one of the preceding embodiments.

According to the technical solution in this embodiment, the point cloud to be segmented is acquired, and the instance segmentation is performed, based on the point cloud processing model, on the point cloud to be segmented. According to the preceding technical solution, the instance segmentation is performed, through the point cloud processing model, on the point cloud to be segmented so that the accuracy with which the instance segmentation is performed on the point cloud is improved.

Operations, including acquisition, storage, and application, on the labeled point cloud, the unlabeled point cloud, and the like involved in the technical solution of the present disclosure conform to relevant laws and regulations and do not violate the public policy doctrine.

According to an embodiment of the present disclosure, the present disclosure also provides an electronic device, a readable storage medium, and a computer program product.

FIG. 7 is a block diagram of an example electronic device 700 that may be configured to implement an embodiment of the present disclosure. The electronic device is intended to represent various forms of digital computers, for example, a laptop computer, a desktop computer, a workbench, a personal digital assistant, a server, a blade server, a mainframe computer, or another applicable computer. The electronic device may also represent various forms of mobile apparatuses, for example, a personal digital assistant, a cellphone, a smartphone, a wearable device, or a similar computing apparatus. Herein the shown components, the connections and relationships between these components, and the functions of these components are illustrative only and are not intended to limit the implementation of the present disclosure as described and/or claimed herein.

As shown in FIG. 7, the electronic device 700 includes a computing unit 701. The computing unit 701 may perform various appropriate actions and processing according to a computer program stored in a read-only memory (ROM) 702 or a computer program loaded into a random-access memory (RAM) 703 from a storage unit 708. Various programs and data required for the operation of the electronic device 700 may also be stored in the RAM 703. The computing unit 701, the ROM 702, and the RAM 703 are connected to each other through a bus 704. An input/output (I/O) interface 705 is also connected to the bus 704.

Multiple components in the electronic device 700 are connected to the I/O interface 705. The multiple components include an input unit 706 such as a keyboard or a mouse, an output unit 707 such as various types of displays or speakers, the storage unit 708 such as a magnetic disk or an optical disk, and a communication unit 709 such as a network card, a modem, or a wireless communication transceiver. The communication unit 709 allows the electronic device 700 to exchange information/data with other devices over a computer network such as the Internet and/or various telecommunications networks.

The computing unit 701 may be various general-purpose and/or special-purpose processing components having processing and computing capabilities. Examples of the computing unit 701 include, but are not limited to, a central processing unit (CPU), a graphics processing unit (GPU), a special-purpose artificial intelligence (AI) computing chip, a computing unit executing machine learning models and algorithms, a digital signal processor (DSP), and any appropriate processor, controller, and microcontroller. The computing unit 701 performs various methods and processing described above, such as the method for training a point cloud processing model or the method for performing instance segmentation on a point cloud. For example, in some embodiments, the method for training a point cloud processing model or the method for performing instance segmentation on a point cloud may be implemented as computer software programs tangibly contained in a machine-readable medium such as the storage unit 708. In some embodiments, part or all of computer programs may be loaded and/or installed on the electronic device 700 via the ROM 702 and/or the communication unit 709. When the computer programs are loaded to the RAM 703 and executed by the computing unit 701, one or more steps of the preceding method for training a point cloud processing model or the preceding method for performing instance segmentation on a point cloud may be performed. Alternatively, in other embodiments, the computing unit 701 may be configured, in any other appropriate manner (for example, by means of firmware), to perform the method for training a point cloud processing model or the method for performing instance segmentation on a point cloud.

Herein various embodiments of the preceding systems and techniques may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), computer hardware, firmware, software, and/or combinations thereof. The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input apparatus, and at least one output apparatus and transmitting data and instructions to the memory system, the at least one input apparatus, and the at least one output apparatus.

Program codes for implementation of the methods of the present disclosure may be written in one programming language or any combination of multiple programming languages. The program codes may be provided for the processor or controller of a general-purpose computer, a special-purpose computer, or another programmable data processing apparatus to enable functions/operations specified in flowcharts and/or block diagrams to be implemented when the program codes are executed by the processor or controller. The program codes may be executed entirely on a machine, partly on a machine, as a stand-alone software package, partly on a machine and partly on a remote machine, or entirely on a remote machine or a server.

In the context of the present disclosure, the machine-readable medium may be a tangible medium that may include or store a program that is used by or in conjunction with a system, apparatus, or device that executes instructions. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any appropriate combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device, or any appropriate combination thereof.

In order that interaction with a user is provided, the systems and techniques described herein may be implemented on a computer. The computer has a display apparatus (for example, a cathode-ray tube (CRT) or a liquid-crystal display (LCD) monitor) for displaying information to the user and a keyboard and a pointing apparatus (for example, a mouse or a trackball) through which the user can provide input to the computer. Other types of apparatuses may also be used for providing interaction with a user. For example, feedback provided for the user may be sensory feedback in any form (for example, visual feedback, auditory feedback, or haptic feedback). Moreover, input from the user may be received in any form (including acoustic input, voice input, or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein), or a computing system including any combination of such back-end, middleware, or front-end components. Components of a system may be interconnected by any form or medium of digital data communication (for example, a communication network). Examples of the communication network include a local area network (LAN), a wide area network (WAN), and the Internet.

The computing system may include clients and servers. The clients and the servers are usually far away from each other and generally interact through the communication network. The relationship between the client and the server arises by virtue of computer programs running on respective computers and having a client-server relationship to each other. The server may be a cloud server, a server of a distributed system, or a server combined with a blockchain.

Artificial intelligence is the study of using computers to simulate certain human thinking processes and intelligent behaviors (such as learning, reasoning, thinking, and planning), which has both hardware-level technologies and software-level technologies. Artificial intelligence hardware technologies generally include technologies such as sensors, special-purpose artificial intelligence chips, cloud computing, distributed storage, and big data processing. Artificial intelligence software technologies mainly include several major technologies such as computer vision technologies, speech recognition technologies, natural language processing technologies, machine learning/deep learning technologies, big data processing technologies, and knowledge graph technologies.

Cloud computing refers to a technical system that accesses flexible and scalable shared physical or virtual resource pools through a network, where resources may include servers, operating systems, networks, software, applications, and storage devices and may deploy and manage resources on demand and in a self-service manner. The cloud computing technology can provide efficient and powerful data processing capabilities for artificial intelligence, blockchain, and other technical applications and model training.

It is to be understood that various forms of the preceding flows may be used, with steps reordered, added, or removed. For example, the steps described in the present disclosure may be executed in parallel, in sequence, or in a different order as long as the desired result of the technical solution provided in the present disclosure is achieved. The execution sequence of these steps is not limited herein.

The scope of the present disclosure is not limited to the preceding embodiments. It is to be understood by those skilled in the art that various modifications, combinations, subcombinations, and substitutions may be made depending on design requirements and other factors. Any modification, equivalent substitution, improvement, and the like made within the spirit and principle of the present disclosure are within the scope of the present disclosure.

What is claimed is:

1. A method for training a point cloud processing model, comprising:
labeling an unlabeled point cloud according to a labeled point cloud to obtain a sample point cloud;
inputting the sample point cloud to a point cloud processing model to obtain first predicted semantic information of the sample point cloud and a first predicted offset of the sample point cloud;
determining a training loss according to the first predicted semantic information, the first predicted offset, a sample label corresponding to the sample point cloud, and original coordinate information of the sample point cloud; and
training the point cloud processing model with the training loss.

2. The method according to claim 1, wherein the labeling the unlabeled point cloud according to the labeled point cloud to obtain the sample point cloud comprises:
performing supervoxel segmentation on an original point cloud according to point cloud geometry information to obtain a first supervoxel; and
labeling an unlabeled point cloud in the first supervoxel according to a labeled point cloud in the first supervoxel to obtain the sample point cloud.

3. The method according to claim 1, wherein the labeling the unlabeled point cloud according to the labeled point cloud to obtain the sample point cloud comprises:
inputting the unlabeled point cloud to the point cloud processing model to obtain second predicted semantic information of the unlabeled point cloud, a second predicted offset of the unlabeled point cloud, and first confidence information of the unlabeled point cloud; wherein the point cloud processing model is obtained by training an initial model with the labeled point cloud;
screening the unlabeled point cloud according to the first confidence information to obtain an available point cloud;
determining a pseudo-label of the available point cloud according to second predicted semantic information of the available point cloud and a second predicted offset of the available point cloud; and
configuring the available point cloud as the sample point cloud.

4. The method according to claim 3, wherein the determining the pseudo-label of the available point cloud according to the second predicted semantic information of the available point cloud and the second predicted offset of the available point cloud comprises:
determining a semantic pseudo-label of the available point cloud according to the second predicted semantic information of the available point cloud; and
determining an offset pseudo-label of the available point cloud according to the second predicted offset of the available point cloud.

5. The method according to claim 4, wherein the determining the offset pseudo-label of the available point cloud according to the second predicted offset of the available point cloud comprises:
determining associated point clouds of a second supervoxel from available point clouds;
determining, according to second predicted offsets of the associated point clouds and original coordinate information of the associated point clouds, an instance center corresponding to the second supervoxel;
determining an offset pseudo-label of an associated point cloud among the associated point clouds according to the instance center corresponding to the second supervoxel and original coordinate information of the associated point cloud; and
configuring the offset pseudo-label of the associated point cloud as the offset pseudo-label of the available point cloud.

6. The method according to claim 3, wherein the screening the unlabeled point cloud according to the first confidence information to obtain the available point cloud comprises:
screening the unlabeled point cloud according to the first confidence information to obtain a candidate point cloud;
clustering the candidate point cloud according to a second predicted offset of the candidate point cloud and original coordinate information of the candidate point cloud to obtain a candidate instance;
inputting an instance feature of the candidate instance to a correction model to obtain second confidence information corresponding to an output result of the correction model; and
screening the candidate instance according to the second confidence information and determining the available point cloud according to a screening result.

7. The method according to claim 1, wherein the determining the training loss according to the first predicted semantic information, the first predicted offset, the sample label corresponding to the sample point cloud, and the original coordinate information of the sample point cloud comprises:
determining a first loss according to the first predicted semantic information and a semantic label in the sample label corresponding to the sample point cloud;
determining a second loss according to the first predicted offset and the original coordinate information of the sample point cloud;
determining a third loss according to the first predicted offset and an offset label in the sample label; and
determining the training loss according to the first loss, the second loss, and the third loss.

8. A method for performing instance segmentation on a point cloud, comprising:
acquiring a point cloud to be segmented; and
performing, based on a point cloud processing model, instance segmentation on the point cloud to be segmented, wherein the point cloud processing model is trained through the method for training a point cloud processing model according to claim 1.

9. An electronic device, comprising:
at least one processor; and
a memory communicatively connected to the at least one processor; wherein,
the memory stores instructions executable by the at least one processor, and the instructions are executed by the at least one processor to cause the at least one processor to perform a method for training a point cloud processing model, wherein the method comprises:
labeling an unlabeled point cloud according to a labeled point cloud to obtain a sample point cloud;
inputting the sample point cloud to a point cloud processing model to obtain first predicted semantic information of the sample point cloud and a first predicted offset of the sample point cloud;
determining a training loss according to the first predicted semantic information, the first predicted offset, a sample label corresponding to the sample point cloud, and original coordinate information of the sample point cloud; and
training the point cloud processing model with the training loss.

10. The electronic device according to claim 9, wherein the labeling the unlabeled point cloud according to the labeled point cloud to obtain the sample point cloud comprises:
performing supervoxel segmentation on an original point cloud according to point cloud geometry information to obtain a first supervoxel; and
labeling an unlabeled point cloud in the first supervoxel according to a labeled point cloud in the first supervoxel to obtain the sample point cloud.

11. The electronic device according to claim 9, wherein the labeling the unlabeled point cloud according to the labeled point cloud to obtain the sample point cloud comprises:
inputting the unlabeled point cloud to the point cloud processing model to obtain second predicted semantic information of the unlabeled point cloud, a second predicted offset of the unlabeled point cloud, and first confidence information of the unlabeled point cloud; wherein the point cloud processing model is obtained by training an initial model with the labeled point cloud;
screening the unlabeled point cloud according to the first confidence information to obtain an available point cloud;
determining a pseudo-label of the available point cloud according to second predicted semantic information of the available point cloud and a second predicted offset of the available point cloud; and
configuring the available point cloud as the sample point cloud.

12. The electronic device according to claim 11, wherein the determining the pseudo-label of the available point cloud according to the second predicted semantic information of the available point cloud and the second predicted offset of the available point cloud comprises:
determining a semantic pseudo-label of the available point cloud according to the second predicted semantic information of the available point cloud; and
determining an offset pseudo-label of the available point cloud according to the second predicted offset of the available point cloud.

13. The electronic device according to claim 12, wherein the determining the offset pseudo-label of the available point cloud according to the second predicted offset of the available point cloud comprises:
determining associated point clouds of a second supervoxel from available point clouds;
determining, according to second predicted offsets of the associated point clouds and original coordinate information of the associated point clouds, an instance center corresponding to the second supervoxel;
determining an offset pseudo-label of an associated point cloud among the associated point clouds according to the instance center corresponding to the second supervoxel and original coordinate information of the associated point cloud; and
configuring the offset pseudo-label of the associated point cloud as the offset pseudo-label of the available point cloud.

14. The electronic device according to claim 11, wherein the screening the unlabeled point cloud according to the first confidence information to obtain the available point cloud comprises:
screening the unlabeled point cloud according to the first confidence information to obtain a candidate point cloud;
clustering the candidate point cloud according to a second predicted offset of the candidate point cloud and original coordinate information of the candidate point cloud to obtain a candidate instance;
inputting an instance feature of the candidate instance to a correction model to obtain second confidence information corresponding to an output result of the correction model; and
screening the candidate instance according to the second confidence information and determining the available point cloud according to a screening result.

15. The electronic device according to claim 9, wherein the determining the training loss according to the first predicted semantic information, the first predicted offset, the sample label corresponding to the sample point cloud, and the original coordinate information of the sample point cloud comprises:
determining a first loss according to the first predicted semantic information and a semantic label in the sample label corresponding to the sample point cloud;
determining a second loss according to the first predicted offset and the original coordinate information of the sample point cloud;
determining a third loss according to the first predicted offset and an offset label in the sample label; and
determining the training loss according to the first loss, the second loss, and the third loss.

16. A non-transitory computer-readable storage medium storing computer instructions for causing a computer to perform a method for training a point cloud processing model, wherein the method comprises:
labeling an unlabeled point cloud according to a labeled point cloud to obtain a sample point cloud;
inputting the sample point cloud to a point cloud processing model to obtain first predicted semantic information of the sample point cloud and a first predicted offset of the sample point cloud;
determining a training loss according to the first predicted semantic information, the first predicted offset, a sample label corresponding to the sample point cloud, and original coordinate information of the sample point cloud; and
training the point cloud processing model with the training loss.

17. The non-transitory computer-readable storage medium according to claim 16, wherein the labeling the unlabeled point cloud according to the labeled point cloud to obtain the sample point cloud comprises:
performing supervoxel segmentation on an original point cloud according to point cloud geometry information to obtain a first supervoxel; and
labeling an unlabeled point cloud in the first supervoxel according to a labeled point cloud in the first supervoxel to obtain the sample point cloud.

18. The non-transitory computer-readable storage medium according to claim 16, wherein the labeling the unlabeled point cloud according to the labeled point cloud to obtain the sample point cloud comprises:
inputting the unlabeled point cloud to the point cloud processing model to obtain second predicted semantic information of the unlabeled point cloud, a second predicted offset of the unlabeled point cloud, and first confidence information of the unlabeled point cloud; wherein the point cloud processing model is obtained by training an initial model with the labeled point cloud;
screening the unlabeled point cloud according to the first confidence information to obtain an available point cloud;
determining a pseudo-label of the available point cloud according to second predicted semantic information of the available point cloud and a second predicted offset of the available point cloud; and
configuring the available point cloud as the sample point cloud.

19. The non-transitory computer-readable storage medium according to claim 18, wherein the determining the pseudo-label of the available point cloud according to the second predicted semantic information of the available point cloud and the second predicted offset of the available point cloud comprises:
determining a semantic pseudo-label of the available point cloud according to the second predicted semantic information of the available point cloud; and
determining an offset pseudo-label of the available point cloud according to the second predicted offset of the available point cloud.

20. The non-transitory computer-readable storage medium according to claim 19, wherein the determining the offset pseudo-label of the available point cloud according to the second predicted offset of the available point cloud comprises:
determining associated point clouds of a second supervoxel from available point clouds;
determining, according to second predicted offsets of the associated point clouds and original coordinate information of the associated point clouds, an instance center corresponding to the second supervoxel;
determining an offset pseudo-label of an associated point cloud among the associated point clouds according to the instance center corresponding to the second supervoxel and original coordinate information of the associated point cloud; and
configuring the offset pseudo-label of the associated point cloud as the offset pseudo-label of the available point cloud.
